(19) United States
(12) Patent Application Publication
(10) Pub. No.: US 2013/0046634 A1
(43) Pub. Date: Feb. 21, 2013

(54) COMBINING OFFERS FROM MULTIPLE MERCHANTS BASED ON THE GEOGRAPHIC PROXIMITY OF THE MERCHANTS

(71) Applicants: David M. Grigg, Rock Hill, SC (US); Matthew A. Calman, Charlotte, NC (US); Raja Bose, Charlotte, NC (US)

(72) Inventors: David M. Grigg, Rock Hill, SC (US); Matthew A. Calman, Charlotte, NC (US); Raja Bose, Charlotte, NC (US)

(73) Assignee: BANK OF AMERICA CORPORATION, Charlotte, NC (US)

(21) Appl. No.: 13/213,995

(22) Filed: Aug. 19, 2011

(51) Int. Cl. G06Q 30/00

(52) U.S. Cl. 705/14.58

(57) ABSTRACT

Embodiments of the invention are directed to a system, method, or computer program product for providing offers to purchase products or services to a user, the offers being for products of merchants located within geographic proximity to each other, to entice a user to visit that location. Offers may be received by a user throughout a day or when the user enters into a transaction. Once the user enters into a transaction at a merchant, the financial institution may receive data regarding that transaction. The data may provide the financial institution an indication as to the user's location and products the user is purchasing. The financial institution may then provide the user with offers to purchase other products. These offers may be for products similar to the products the user is currently purchasing. These offers, however, are within are for merchants within close geographic proximity to each other. These offers may entice users to enter other stores within a similar geographic location, such that the user may add to his/her shopping experience by frequenting merchants not typically frequented by that user.

### BACKGROUND

Individuals typically have a variety of choices when selecting a product to purchase, such as several different brands for a product. Not only may the individual have a variety of choices when selecting a product, he/she may also have a variety of merchants that may sell that product. For example, if the individual is shopping for clothing, he/she has several brand options to select from. Furthermore, there may be several merchants that sell the same brand or similar brand products within a close geographic proximity to the individual or other merchants. Therefore, the individual may have several merchants that may provide him/her with the products he/she is looking for.

Many factors may play a role in an individual's selection of a particular product. The individual's perception of the brand, past use of a product, past use of a brand, advertisement of a product, advertisement of a brand, offers for discounts for a product, etc., may all have a direct correlation with which products an individual may select to purchase. Not only does the brand of product play a role in product purchasing, merchants may have a role in product purchasing as well. The individual's perception of the merchant, merchant discounts, merchant advertisement, convenience of a merchant's store, etc. may also have a direct correlation with products an individual may select to purchase.

Although many factors may play a role in an individual's initial selection of a product, an individual will typically establish a routine whereby the individual shops at the same merchant (and the same merchant location) for the same or similar products. This may be true, even if the individual has several merchants to select from within any given area. For example, the individual shopping for clothing may have several different merchants that carry the same or similar clothing to select from. However, the individual may typically always go to the same merchant to purchase clothing, without considering the other merchants in the area. Therefore, an individual gets into a routine of always going to the same merchants to purchase products. If this is the case, the individual may miss an opportunity to save money or experience a different merchant, simply because the individual is in a routine.

Therefore, a need exists for individuals to be able to consider other merchants that may save the individual money, without the individual having to search for these merchants.

### BRIEF SUMMARY

Embodiments of the present invention address the above needs and/or achieve other advantages by providing apparatuses (e.g., a system, computer program product and/or other devices) and methods for providing users with offers based on the user's current location and/or recent transactions. These offers may be for products found at merchants that are in close geographic proximity to each other, thus these offers entice the user to travel to the area of the merchants. Furthermore, these offers may be for products similar in scope to the products the user recently purchased. In this way, the user may already be out shopping for products and the offers presented to the user may be for similar products. Thus, the offers may attract the user, whom is already in a “shopping mode” to other merchants that are in close geographic proximity to each other. Therefore, the invention provides a user with an incentive to frequent other merchants within geographic proximity to each other by providing offers for several products that the user may be interested in purchasing.

In some embodiments, a recognition of a user transaction triggers providing the user an offer. For example, if a user is at a merchant purchasing a product, that purchase may trigger an offer for similar products at several merchants located near each other. In this way, the offers may entice the user to move from his/her current location to the shopping location of the merchants providing the offers.

In some embodiments, transaction history data may trigger providing an offer to a user at any time throughout the day. In this way, the system may recognize that the user always purchases the same or similar products. Furthermore, the system may recognize that the user always shops at the merchants located at Shopping Center A for these products. The system may provide the user with offers for the merchants located at Shopping Center B, which may have several merchants with the same or similar products to those in which the user normally purchases at Shopping Center A. In this way, the offers may provide the user with motivation to visit Shopping Center B instead of Shopping Center A, the next time he/she is shopping for particular products.

In yet other embodiments, the offers provided to the user may be based on manually inputted data from the user. The manually inputted data may indicate products the user may wish to purchase. Such that offers may be provided to the user for products the user is interested in purchasing. These offers may be for merchants that are co-located, such to entice the user to visit the area of the merchants.

Offers may be provided to a user for a merchant or group of merchants co-located, such that the offers may entice the user to visit the merchant area of the merchants providing the offers. A merchant area, as used herein is a geographic area providing one or more merchants within the area. For example, a mall may have several department stores, sporting goods stores, clothing stores, etc. The mall may be considered a merchant area. In another example, a large department store may be isolated from any other merchants. In this way, the large department store may also constitute a merchant area. Merchant areas are not defined by a specific radius or area of land, but instead by the clustering of various merchants.

The offers provided to the user may be based on the user's location or the user's transaction history. In this way, the user's location and/or transactions aid the system in determining proper offers to provide the user.

Offers that may be provided to the user may be in the form of a discount, rebate, coupon, etc. that may expire within a predetermined amount of time or may be available to the user at any time he/she wishes to make a transaction. In some embodiments, the offers may be for products that the user previously requested. In some embodiments, offers may be for specific products. In yet other embodiments, offers may be available for use at specific merchants.

The user's location may be determined by location data. Location data may be established by the point-of-sale (POS) device, mobile device of the user, global positioning systems (GPS) data, accelerometer data, address of the user, shopping patterns of the user, social media, or location of the merchant. For example, if a user uses a credit card to complete a transaction, the system may recognize the location of the POS system utilized in the transaction. In this way, the system may recognize the merchant area that the user is shopping within and the products the user is purchasing in that area. The system may then provide, via the user's mobile device, offers for products at merchants in a different merchant area, thus to entice the user to travel to a different merchant area.

The user's transaction history may be determined by transaction data. A financial institution may be uniquely situated to receive data from a merchant if the user is purchasing a product using a purchase method other than cash. In this way, a financial institution may know the location of the user in real-time or close thereto, the amount the user is spending, social media, shopping patterns, and/or the general product classification the user is purchasing. In one example, the user may purchase groceries every Thursday at the same merchant area, the system may recognize this and provide the user with offers for groceries at a different merchant location valid for Thursday. In another example, the user may use a credit card to complete a transaction at a sporting goods store. The financial institution may receive the transaction information to authorize the completion of the transaction. Because of the financial institution's unique position, the financial institution may derive from the authorization process the general geographical position of the user and that the user most likely purchasing sporting equipment or clothing. In this regard, many of the embodiments herein disclosed leverage financial institution data, which is uniquely specific to financial institution. Furthermore, the financial institution may have data relating to purchases the user has made in the past. In this way, the financial institution may recognize that the user purchases from that specific sporting goods store every week/month/year. Furthermore, the financial institution may recognize that the user does most of his/her shopping within the merchant area of that sporting goods store. Therefore, from this data, the system may determine to provide offers to the user for a sporting goods store and other merchants in a different merchant area, such to entice the user to shop at a different merchant area.

The system may then match the user, based on location data, transaction data, and/or user manual input with an offer. Matching an offer to a user based on the user's location and transaction history allows the system to provide several offers from merchants for products that the user may purchase at locations that the user may or may not frequent for those products. In this way, the offers may entice the user to shop at a different merchant area than the user may typically shop. For example, the system may determine that the user has purchased several products today at a given location. The location may be a shopping mall. In this way, the system may provide offers for similar products from commercial partners located at a different shopping mall. In this way, the offers may entice the user to travel to the shopping mall of the offers. In another example, the system may determine several merchants within geographic proximity to each other and provide the user, whom may be shopping in a different area. These offers may entice a user to go to the area of the merchants providing the offer and shop there instead. Therefore, the system may provide offers to purchase products at merchants that are in geographic proximity to each other. As such, the offers may entice a user to go to merchants that are close by, but the user may not have previously considered visiting.

The offers may be for products similar to the products the user has already purchased that day or may be offers for products different than those products the user has already purchased that day. In this way, the system provides offers to a user via the user's mobile device. The offers may provide motivation for the user to break from his/her shopping routine and discover products that he/she may find beneficial at other merchants. In some embodiments, the offer may be more beneficial to the user if the user has not frequented that merchant. In some embodiments, the offer may be less beneficial to the user if the user has frequented that merchant often. For example, if a user gets coffee at Coffee Shop A every morning, the system may recognize that the individual frequents Coffee Shop A and therefore may not provide an offer for Coffee Shop A or provide a less beneficial offer to the user as compared to Coffee Shop B. However, if Coffee Shop A is a commercial partner of the financial institution providing the program, the system may provide an offer to the user for Coffee Shop A. If Coffee Shop A is not a commercial partner and Coffee Shop B is a commercial partner, the system may provide a more beneficial offer to Coffee Shop B to entice the user to try Coffee Shop B.

Once a match is determined the system may send one or many offers to the user. In some embodiments, the offers may be sent to the user via a network, to the user's mobile device. The user may accept the offer for products associated with merchants in the geographic proximity of the user.

Embodiments of the invention relate to systems, methods, and computer program products for providing offers to a user comprising: receiving financial transaction data associated with a user; determining from the financial transaction data one or more geographic locations where financial transactions in the financial transaction data occurred; determining from a data store of product offers one or more selected product offers offered at a geographic location different from the one or more geographic locations associated with the financial transaction data; and providing the selected product offers to the user associated with the financial transaction data to thereby entice the user to shop at the geographic location different from the one or more geographic locations associated with the financial transaction data.

In some embodiments, determining from the financial transaction data at least one of one or more categories associated with the financial transaction data, wherein said determining selected product offers further comprises determining selected product offers designated in the same categories as the one or more categories associated with the financial transaction data where the products underlying the product offers are offered at geographic locations different from the one or more geographic locations associated with the financial transaction data.

In some embodiments, determining from the financial transaction data at least one of one or more categories associated with the financial transaction data, wherein said determining selected product offers further comprises determining selected merchants that provide products in the same categories as the one or more categories associated with the financial transaction data and providing selected product offers from the selected merchants where the selected merchants are located at geographic locations different from the one or more geographic locations associated with the financial transaction data.

In some embodiments, determining one or more selected product offers comprises determining one or more selected products offered at a geographic location that is a predetermined distance from the one or more geographic locations associated with the financial transaction data. In yet other embodiments, determining one or more selected product offers comprises determining one or more selected products offered at a geographic location that is a predetermined distance from an address associated with the user. Determining one or more selected product offers may further comprise determining one or more selected products offered at a geographic location that is a predetermined distance from the current location of the user. Determining one or more selected product offers may further comprise determining product offers associated with a merchant area that is different from the one or more geographic locations where financial transactions in the financial transaction data occurred. In other embodiments, determining one or more selected product offers comprises varying the value of the product offers based on a difference in a geographic location associated with the product offers and the geographic location associated with the financial transaction data.

In some embodiments, determining from the financial transaction data one or more geographic locations where financial transactions in the financial transaction data occurred is based at least in part on a point-of-sale device associated with the financial transactions.

### BRIEF DESCRIPTION OF THE DRAWINGS

Having thus described embodiments of the invention in general terms, reference will now be made to the accompanying drawings, wherein:

FIG. 1 provides a high level process flow illustrating a geographic proximity offer program process, in accordance with one embodiment of the present invention;

FIG. 2 provides a geographic proximity offer system environment, in accordance with one embodiment of the present invention;

FIG. 3 provides a flow chart illustrating a process of receiving offers, in accordance with one embodiment of the present invention;

FIG. 4 provides a process map illustrating the offer selection process, in accordance with one embodiment of the present invention;

FIG. 5 provides a process map illustrating a user's selection process, in accordance with one embodiment of the present invention;

FIG. 6 provides a watch list interface, in accordance with one embodiment of the present invention;

FIG. 7 provides an offer interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Furthermore, as used herein, the term “product” shall mean any good, service, event, etc. that may be offered by a merchant. In addition, the term “offer” is used herein to denote any form of offer, promotion, rebate, coupon, incentive, and/or the like offered for the purchase, lease, and/or the like of a product. A “transaction” as used herein may refer to a purchase, lease, barter, and/or any other form of transfer of product from a merchant to a user. A “merchant” as used herein may refer to a manufacturer, retailer, service provider, event provider, warehouse, supplier, commercial partner of a financial institution, and/or the like. Furthermore, a “merchant area,” as used herein is a geographic area providing one or more merchants within the area. For example, a mall may have several department stores, sporting goods stores, clothing stores, etc. The mall may be considered a merchant area. In another example, a large department store may be isolated from any other merchants. In this way, the large department store may also constitute a merchant area. Merchant areas are not defined by a specific radius or area of land, but instead by the clustering of various merchants.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to users.

Further, the embodiments described herein may refer to use of a transaction or transaction event to trigger providing offers to a user via the geographic proximity offers program. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As further examples, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile system. Such a device may be referred to herein as a “point-of-sale system” (POS system). A “point-of-sale” (POS) could refer to any location, virtual location or otherwise proximate occurrence of a transaction. A “point-of-sale system” may refer to any device used to perform a transaction, either from the user's perspective, the merchant's perspective or both. In some embodiments, the POS system refers only to a user's system, in other embodiments it refers only to a merchant system, and in yet other embodiments, it refers to both a user device and a merchant device interacting to perform a transaction. For example, in one embodiment, the point-of-sale system refers to the user's mobile device configured to communicate with a merchant's point of sale terminal, whereas in other embodiments, the POS system refers to the merchant's point of sale terminal configured to communicate with a user's mobile device, and in yet other embodiments, the POS system refers to both the user's mobile device and the merchant's point of sale terminal configured to communicate with each other to carry out a transaction.

In some embodiments, a POS system is or includes an interactive computer terminal that is configured to initiate, perform, complete, and/or facilitate one or more transactions. A POS system could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo WHO, PlayStation Portable®, etc.), and/or various combinations of the foregoing.

In some embodiments, a POS system is operated in a public place (e.g., on a street corner, at the doorstep of a private residence, in an open market, at a public rest stop, etc.). In other embodiments, the POS system, is additionally or alternatively operated in a place of business (e.g., in a retail store, post office, banking center, grocery store, factory floor, etc.). In accordance with some embodiments, the POS system is not owned by the user of the POS system. Rather, in some embodiments, the POS system is owned by a mobile business operator or a POS operator (e.g., merchant, vendor, salesperson, etc.). In yet other embodiments, the POS system is owned by the financial institution offering the POS system providing functionality in accordance with embodiments of the invention described herein.

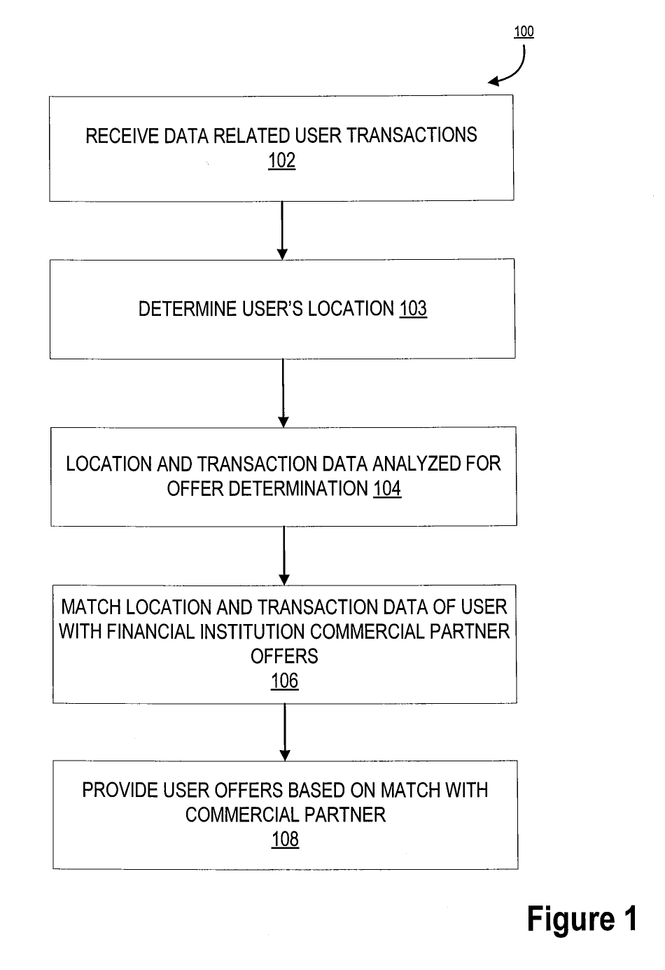

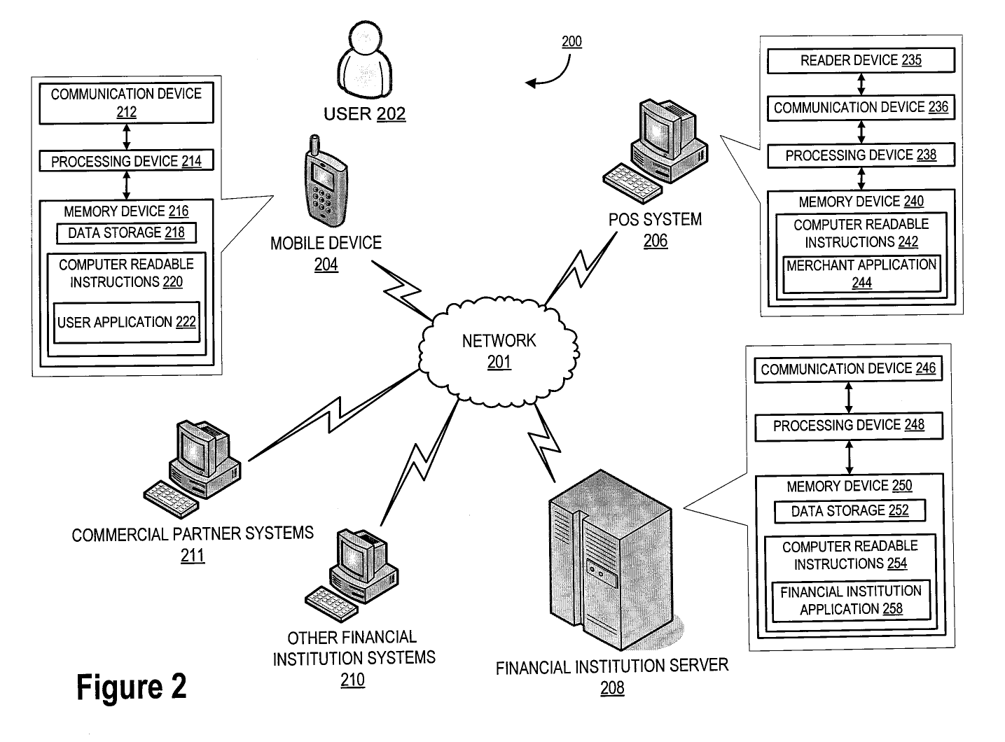

FIG. 1 illustrates a high level process flow for a geographic proximity offer program process 100, which will be discussed in further detail throughout this specification with respect to FIGS. 2 through 7. The first step in the process 100 is to receive data related to a user's transactions in block 102. In some embodiments, transaction data may be received from a financial institution providing accounts to the user. In some embodiments, the user's transaction data may be received from a POS system when a user is making a transaction.

Once transaction data is received, the user's location may be determined therefrom, as illustrated in block 103. In some embodiments, the user's location may be determined based on the transaction data, such as receipt information that a user purchased a product at a specific merchant or the user's transaction history. In some embodiments, the user's location may be determined from global positioning system (GPS) corresponding to the user's mobile device or other user devices. This data is then received at the financial institution or another entity providing the geographic proximity program. In this way, a financial institution may know the location of the user and the most recent purchases of the user in real-time or close thereto when the user performs a debit or credit transactions. For example, if the user provides a credit card for payment of a transaction, the financial institution or entity providing the geographic proximity offer program may be able to determine the location, transaction amount, and type of product the user is purchasing. However, if the user is providing payment for a transaction using cash, the financial institution may not be able to determine the location, transaction amount, or type of product the user is purchasing. Next, in block 104, the system analyzes the location and transaction data to determine an offer that is appropriate to the user. In some embodiments, an appropriate offer may be one for products similar to products the user has purchased in the past. In some embodiments, and appropriate offer may be one for products different than what the user has purchased in the past. In block 106, the system may match the location and transaction data of the user to offers provided by commercial partners of a financial institution. In some embodiments, an offer that matches to the user may be based on the geographic proximity the merchants associated with the offers, such that the user is provided several offers from the same merchant area to entice the user to travel to that merchant area. Finally, once a match or several matches are made, the offers are provided to the user in block 108. These offers are for merchants that are in geographic proximity to each other. In this way, the offers may entice a user to shop in the area of the merchants providing the offers. Furthermore, the user may provide the offers from the geographic proximity offer program to other individuals associated with the user, such that these offer may entice others to travel to a merchant area to shop.

FIG. 2 provides a geographic proximity offer program system environment 200, in accordance with one embodiment of the present invention. As illustrated in FIG. 2, the financial institution server 208 is operatively coupled, via a network 201 to the mobile device 204, to the POS system 206, to other financial institution systems 210, and to the commercial partner system 211. In this way, the financial institution server 208 can send information to and receive information from the mobile device 204, the POS system 206, the other financial institution systems 210, and the commercial partner system 211, to match and provide geographically proximate offers to a user 202. FIG. 2 illustrates only one example of an embodiment of a geographic proximity offer program system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual making a financial transaction. The financial transaction may be made at a POS system 206 of a merchant, online or offline, over the phone, at the merchant's place of business and/or other transaction means. The purchase may be made by the user 202 using a mobile device 204, such as a mobile wallet (i.e. smart phone, PDA, etc.) or other types of payment systems that communicate with POS systems 206 and/or financial institution servers 208 to allow the user 202 to make a transaction. In other embodiments, the user 202 may enter into transactions using a card with stored magnetic information, digital information, or other like payment device that stores information that may be transferred to a POS system 206 and/or a financial institution server 208 to allow a user 202 to enter into a transaction, such as a credit card, debit card, gift card, and/or the like. In this way, the system may determine the location and transaction data from the transaction. In some embodiments, the user 202 may be a merchant or a person, employee, agent, independent contractor, etc. acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the POS system 206, the mobile device 204, the commercial partner systems 211, and the other financial institution computer systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the financial institution accounts including but not limited to data created and/or used by the financial institution application 258 or the financial information of users 202. The data storage 252 may also store all offers received from commercial partner systems 211 such that the financial institution application 258 may match the offers stored with a user's 202 location and recent transactions.

In the embodiment illustrated in FIG. 2 and described throughout much of this specification, the financial institution application 258 allows the user 202 to interact with the system. First, the financial institution application 258 allows a user 202 to opt-in to the geographic based offer program, via the user's 202 mobile device 204. Next, the financial institution application 258 allows the user 202 to manual input related to products the user 202 may wish to purchase. Both opting into the program and manually inputting watch list products may be performed by a user 202 using an interface provided to the user's 202 mobile device from the financial institution application 258 via a network 201.

In some embodiments, the financial institution application 258 allows the user 202 to communicate, via the mobile device 204, to indicate a desire to opt-in to the geographic based offer program. In other embodiments, the user 202 may not have to opt-in to the program, but instead, may be automatically sent offers based on the user's 202 payment means or location when purchasing a product. For example, if the user 202 is completing a transaction using a means of payment provided by the financial institution, the financial institution may automatically direct offers to the user's 202 mobile device 204 based on the user's 202 location and transaction data.

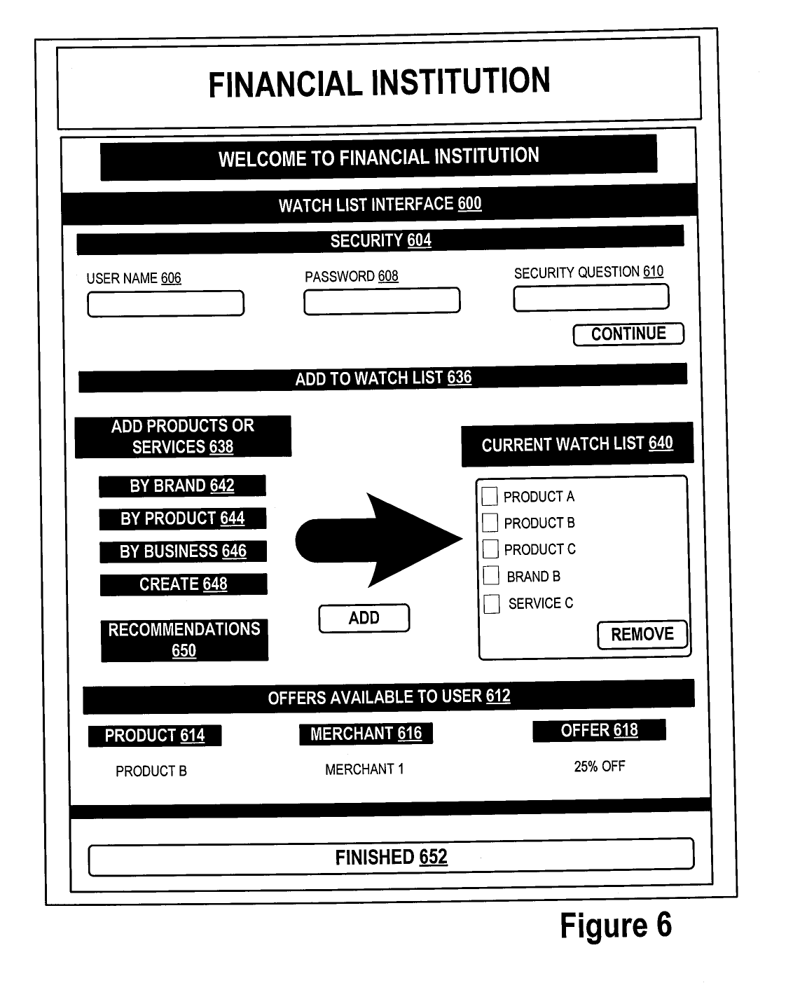

In some embodiments, the financial institution application 258 allows the user 202 to communicate, via the mobile device 204, to indicate products that the user 202 may wish to purchase. This communication may be in the form of text communications, voice communications, or the like. Typically, products the user 202 may wish to purchase may be provided by the user 202 through a watch list interface, such as that illustrated in FIG. 6. The financial institution application 258 may receive the watch list products from the user 202 once the user 202 has inputted the products onto the interface. Once the financial institution application 258 receives this data, it may be stored in the memory device 250, such that if a commercial partner provides an offer for the same or similar product that is on the watch list of the user 202 the financial institution application 258 may notify the user 202 once the user 202 is in proximity to that product or merchant. Furthermore, the financial institution application 258 may contact commercial partners, via the network 201 through a commercial partner system 211 to enquire as to whether a product on the user's 202 watch list may be eligible for an offer. For example, the user 202 may put a television on his/her watch list. At that point, the financial institution application 258 may search the data storage 252 to determine if a commercial partner or merchant providing offers via the geographic proximity program are providing an offer for the same or similar television at a merchant area the user 202 does not frequent.

If the user 202 is not currently in a merchant area making a transaction, the financial institution application 258 may communicate with commercial partner systems 211 to determine if one of the commercial partners in a merchant area the user's 202 does not frequent that would be willing to provide an offer for a television. If a commercial partner is willing to do so, the user 202 may receive the offer for a television from that commercial partner from the financial institution application 258. In other embodiments, if the user 202 is in a merchant area making a transaction, the financial institution application 258 may provide the user 202 with several offers, including one for a television, from merchants located at a different merchant area. Therefore, enticing the user 202 to shop in a merchant area of the merchant providing the offer for the television, which may be different than the merchant area the user 202 is currently shopping.

The financial institution application 258 may also receive data from the commercial partner systems 211 and store the data within the data storage 252. Data from the commercial partner systems 211 may include offers for any products manufactured, sold, produced, or the like by the commercial partner that the commercial partner may wish to include in the program. For example, the commercial partner of the financial institution may manufacture electronic equipment. The commercial partner may manufacture several models of speakers, CD players, DVD players, televisions, etc. The commercial partner may select which of these models the commercial partner may wish to provide an offer to a user 202, through the geographic offer program. Furthermore, the commercial partner may determine the type of offer the commercial partner is willing to provide to the user 202. For example, the commercial partner may offer a percentage off the price of a product, coupons, by-one-get-one free offers, promotions, etc. In some embodiments, the offers may expire within a pre-determined time frame. For example, an offer may be valid for a specific day/weekend/week/month. The commercial partner may provide several different offers for one product, several products, or all products the commercial partner manufactures or sells. In some embodiments, the amount of offers available for a product or amount of discount for a product may be contingent on the number of users 202 the offer is sent to. For example, if the offer is extremely beneficial, or a large value, the commercial partner may not want to provide a lot of users 202 with the offer. The commercial partner may want to limit the number of offers given to users 202 or limit the value of some offers compared to others. For example, the commercial partner may want to reward users 202 that frequent the commercial partner merchant, therefore the commercial partner may elect to provide greater discounts to those users 202 whom have frequented the commercial partner merchant establishment. In another example, a commercial partner may want to attract new customers, therefore the commercial partner may elect to provide greater discounts to those users 202 whom have not ever been to the commercial partner.

The offers provided through the geographic proximity offer program may be more beneficial to a user 202 than other offers that may be provided by merchants. This is largely due to the unique position the financial institution is in with respect to the commercial partner. In this way, the offers may entice the user 202 to start shopping at a location different that the one he/she is currently shopping. The commercial partner may have commercial banking needs such as mortgages, lines of credit, financial accounts, etc. that may be provided by the financial institution. In exchange for providing these financial services to the commercial partner the commercial partner may provide special offers to the financial institution. In this way, the commercial partner may receive financial services from the financial institution, while the financial institution may be able to receive discounted products from the commercial partner. In some embodiments, the commercial partner may not be associated with the financial institution, but instead, wish to provide offers to users 202 through the geographic proximity offer program.

These discounted products may be passed on to the users 202 of the geographic proximity offer program. Thereafter, the users 202 may receive these offers and frequent the merchants associated with the commercial partners. Thus, the offers provided through the geographic proximity offer program may comprise of these special offers that are exclusively provided to the financial institution from a commercial partner. In this way, the user 202 may receive more beneficial offers through the geographic proximity offer program than through any other offer programs.

The commercial partner, through the commercial partner system 211 may provide the financial institution application 258 data with respect to the offers available. The financial institution application 258 may then store the data related to the commercial partner offer such as, but not limited to the product, the offer, the location for the offer, etc. In this way, the financial institution application 258 may have access to all offers available from all commercial partners, in a database, to utilize to match the user 202 with one or more offers.

The financial institution application 258 may also receive data from the POS system 206. The POS system 206, as explained in further detail below, allows the financial institution application 258 to determine the location of the user 202 and recent transaction of the user 202. Because the POS system may send authentication for a user 202 transaction to the financial institution server 208 or other financial institution servers 210, the financial institution application 258 may receive data regarding the transaction from the financial institution server 208 or the other financial institution servers 210. In this way, the financial institution application 258 may determine and store in the data storage 252 information relating to the location of the transaction and the products of the transaction. The location of the transaction may be determined due to the POS location or other means such as global positioning systems (GPS), mobile device 204 locators, or the like. In some embodiments, the location data is determined by a POS system 206. In this way the location data may be analyzed by the financial institution application 258 to determine the merchant area the user 202 is currently shopping in, such that if the user 202 is within a merchant area the system may recognize the merchant area and provide offers for merchants in a different merchant area or the same merchant area. In this way, the location data provided by the POS system 206 to the financial institution application 258 may aid in providing the user 202 offers for products from merchants within a merchant area. In some embodiments, the merchant area may be the same merchant area the user 202 is currently shopping. In some embodiments the merchant area may be a different merchant area than the one the user 202 is currently shopping.

In some embodiments, the location data is determined by GPS data of the user's 202 mobile device 204 or other means not associated with the POS system 206. In this way, the user 202 may not be within a merchant area, but instead at home, work, etc. The location data may provide an indication of merchant areas within a specific range from the user's 202 location, such that the system may provide offers to the user 202 for merchant areas that are at least within the same city/state that the user 202 is currently in. In some embodiments, the merchant area may be the same merchant area the user 202 typically shops. In some embodiments the merchant area may be a different merchant area than the one the user 202 typically shops.

In some embodiments, the location of the user 202 may not be required for the financial institution application 258 to provide offers from merchants to the users 202. In this example, the merchants of the provided offers may be within the same merchant area, such that the user 202 receiving the offers may be enticed to travel to the location of the merchants within the merchant area.

The data received by the financial institution application 258 from the POS system 206 may also include transaction data. A financial institution, whether associated with the financial institution server 208 or other financial institution systems 210 may be uniquely situated to receive data from a merchant if a user 202 purchases a product using a purchase method associated with that financial institution. In this way, the financial institution application 258 may determine the location of the user 202 in real-time or close thereto, the amount the user 202 is spending, and/or the general product classification the user 202 is purchasing. For example, the user may use a credit card to complete a transaction at a sporting goods store. From this transaction the financial institution application 258 may determine the general geographical position of the user 202 and predicted classification of products that the user 202 purchased, in this example, sporting equipment or clothing.

The financial institution application 258 may also receive data from other financial institution systems 210. In this way, if a user 202 utilizes a payment means that may require authorization from another financial institution other than the one providing the geographic proximity offer program, the financial institution application 258 may receive data regarding the user's 202 transaction. Such that, the financial institution application 258 may determine the location and classification of products purchased in the recent transaction.

The data stored within the financial institution application 258 provides computer readable instructions 254 to the processing device 248 to allow for the matching of an offer received from a commercial partner system 211 with a user 202 based on the user's 202 location data, transaction data, and watch list data. The financial institution application 258 stores the matched offers and communicates the offers to a user 202 via a network 201 to the user's 202 mobile device 204.

Matching offers provided by commercial partners with users 202 may require an analysis of the user's 202 location, transactions, and/or watch list. The financial institution application 258 may provided an offer to a user 202 based on one of these factors, all of these factors or a combination of the factors. Furthermore, if more than on offer is being presented to the user 202, the merchants of the offer may be in the same merchant area, thus enticing the user 202 to travel to that merchant area because of the several offers being provided to the user 202 for that area. The financial institution application 258 uses these factors to determine which offers from commercial partners, the offers stored in a database in data storage 252, are appropriate offers for the user 202. In some embodiments, the offer may be for products that it may be determined that the user 202 may be interested in. The match may also be based on the recent purchase of the user 202. For example, if the user 202 has been purchasing clothing all day an offer for a refrigerator would more likely than not be rejected by the user 202. Therefore, the financial institution application 258 considers the recent purchase of the user 202 when determining an offer for the user 202 of the geographic proximity offer program. In some embodiments, the offer may be for a merchant area that the user 202 frequents or is currently located. In yet other embodiments, the offer may be for a merchant area that the user 202 may not frequent and/or may have to travel to.

The user's 202 location may be determined by the financial institution application 258 through location data. Location data may be established by data sent from the POS system 206, GPS data associated with the user 202 or the user's 202 mobile device 204, transaction history data, accelerometer data, etc. to the financial institution application 258. The data from the POS system 206 may include information about where the POS system 206 is located. Therefore, providing the financial institution application 258 with data regarding the geographic area the user 202 is either currently within or was within a short time ago. For example, a POS system 206 may be used by a user 202 at a merchant to complete a transaction. Along with the authentication data needed to authenticate the payment for the purchase of a product, the POS system 206 may also send information as to the location of the merchant to the financial institution. Therefore, the financial institution application 258 may receive address information or at least general geographic indication information for the merchant where the user 202 just completed a transaction. Location data may also be received by the financial institution application 258 from a mobile device 204 of a user 202, the merchant, accelerometer data, GPS data, or the like. In this way, the location of the user 202 may be known, even if the user 202 is not making a purchase. Therefore an offer may be provided to the user 202 at anytime, independent of the user 202 making a transaction.

The user's 202 transaction data may be determined by the financial institution application 258. The user's 202 transaction data may comprise recent transactions or transaction history data. A financial institution may be uniquely situated to receive transaction data from a POS system 206 if the user 202 is utilizing a financial institution payment mechanism for a transaction. The financial institution may receive authentication data from the POS system 206 to authenticate the transaction of the user 202. This authentication data may be used by the financial institution application 258 such that the financial institution application 258 may further determine the location of the user 202 in real-time or close thereto, the amount the user 202 is spending, and/or the general product classification the user 202 is purchasing. In some embodiments, transaction history data may be received from the financial institution directly, other financial institutions, the user 202 directly, etc. and do not necessarily have to be established by information received from a POS device 206. This transaction data may be stored within the financial institution, such that recent transactions as well as transaction history may be acquired by the financial institution application 258. In this way, the financial institution application 258 may determine the locations the user 202 likes to frequent, the merchants the user 202 typically purchases from, the history of transactions of the user 202, and the like to aid in determining appropriate offers to provide the user 202.

The location of the user 202, as described above, allows for the financial institution application 258 to determine offers that the user 202 may be able to travel to. For example, the user 202 may not want to travel over thirty minutes away from his/her current location, in order to use the offers provided by the geographic proximity offer program. However, if the offers are for a merchant area within a reasonable distance from the user's 202 current location, the user 202 may be enticed to travel to that merchant area based on the offers the received. In some embodiments, offers may be presented to the user 202 for products from merchants that are in the same merchant area and not necessarily near the user 202. The amount the user 202 is spending may allow the financial institution application 258 to determine the offers that may be presented to the user 202. For example, if the user 202 is at a grocery store and only spends a small amount, the financial institution application 258 may determine that the user 202 is not shopping that day, but instead only quickly picking up a few items for dinner. Therefore, the financial institution application 258 may provide the user 202 with a few offers or no offer at all. However, if the user 202 is purchasing several clothing items throughout the day, the financial institution application 258 may make several offers to the user 202 because the likelihood of the user 202 using the offer may be greater in that instance. Watch list data may be data that the user 202 provides to the financial institution application 258. The data may comprise product information regarding products that the user 202 wishes to purchase or will purchase in the near future. Watch list data may be provided to the financial institution application 258 from the user 202 by text messaging, social network sites, an application, a mobile application, voice messaging, interfaces, or the like.

In one embodiment, as explained in further detail below, the financial institution application 258, after matching an offer from a commercial partner to a user 202 may present an offer to the user 202. In other embodiments, the financial institution application 258 may present several offers to the user 202. In yet other embodiments, the financial institution application 258 may not present any offers to the user 202. In some embodiments, the financial institution application 258 may present the offers through the communication device 246 of the financial institution server 208 communicating the offer or offers to the user 202 through a network 201 to a mobile device 204 of the user 202. In other embodiments, the financial institution application 258 may send the offer or offers to the user 202 through a network 201 to the POS system 206. In this way, the user 202 may receive an offer to purchase the product that the user 202 is already in the process of purchasing. The offer may be displayed on the POS system 206 such that the user 202 may accept the offer prior to the completion of the transaction.

Furthermore the financial institution application 258 may further comprise an artificial intelligence (AI) or other type of intelligence program provided. In this way, the financial institution application 258 may analyze the user's 202 location data, transaction data, and watch list data as well as the circumstances surrounding the purchase to make an intelligent, yet predicted offer recommendation to the user 202. As the example above indicates, the financial institution application 258 may notice that the user 202 is grabbing something quickly and the user 202 may not be in the “shopping mode.” Thus, the financial institution application 258 may not make any offers or very few offers to the user 202. However, if the financial institution application 258 determines that the user 202 is in a “shopping mode” more offers for more products may be presented to the user 202.

As illustrated in FIG. 2, the POS system 206 generally comprises a reading device 235, a communication device 236, a processing device 238, and a memory device 240. The reading device 235 is operatively coupled to the processing device 238, communication device 236, and the memory device 240. The POS system 206 may include a reader device 235 to receive payment account information from the user 202 through the mobile device 204 and/or other payment devices. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the user's 202 payment account and/or transaction data at the POS system 206 and communicates the information via the communication device 236 over a network 201, to other systems such as, but not limited to the financial institution server 208, other financial institution systems 210, and/or the commercial partner system 211. As such, the communication device 236 generally comprises a modem, server, or other device for communicating with other devices on the network 201.

As further illustrated in FIG. 2, the POS system 206 comprises computer-readable instructions 242 stored in the memory device 240, which in one embodiment includes the computer-readable instructions 242 of a merchant application 244. A POS system 206 may refer to any device used to perform a transaction, either from the user's perspective, the merchant's perspective or both. In some embodiments, the POS system 206 may refer only to a user's device, in other embodiments it refers only to a merchant device, and in yet other embodiments, it refers to both a user device and a merchant device interacting to perform a transaction. For example, in one embodiment, the POS system 206 refers to the user's mobile device configured to communicate with a merchant's point of sale terminal, whereas in other embodiments, the POS system 206 refers to the merchant's point of sale terminal configured to communicate with a user's mobile device, and in yet other embodiments, the POS system 206 refers to both the user's mobile device and the merchant's point of sale terminal configured to communicate with each other to carry out a transaction.

In some embodiments, a POS system 206 is or includes an interactive computer terminal that is configured to initiate, perform, complete, and/or facilitate one or more transactions. A POS system 206 could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo WHO, PlayStation Portable®, etc.), and/or various combinations of the foregoing.

In some embodiments, a POS system 206 is operated in a public place (e.g., on a street corner, at the doorstep of a private residence, in an open market, at a public rest stop, etc.). In other embodiments, the point-of-sale device is additionally or alternatively operated in a place of business (e.g., in a retail store, post office, banking center, grocery store, factory floor, etc.). In accordance with some embodiments, the POS system 206 is not owned by the user of the POS system 206. Rather, in some embodiments, the POS system 206 is owned by a mobile business operator or a POS operator (e.g., merchant, vendor, salesperson, etc.). In yet other embodiments, the POS system 206 is owned by the financial institution offering the POS system 206 providing functionality in accordance with embodiments of the invention described herein.

The POS system 206 as discussed herein may include any point of transaction device, such at a cash register, POS terminal, ATM, smart phone, back end server of a merchant, etc. As such, the POS system 206 may be able perform a sale, an account balance check, a reward transfer, and account money transfer, a user 202 opening up a bank application on his mobile device or computer, a user 202 using his/her e-wallet, and/or the like.

In the embodiment illustrated in FIG. 2, the merchant application 244 allows the POS system 206 to be linked to the financial institution server 208 to communicate, via a network 201, the information related to the transaction being made, such as the transaction type, cost of transaction, product type, merchant location, user 202 location, etc. In this way, the merchant application 224 may provide the financial institution application 258 with location data and recent transaction data, such that the financial institution application 258 may determine an appropriate geographic proximity offer match for the user 202. In one example, the user 202 enters into a transaction at a POS system 206, which processes the transaction and the merchant application 244 allows communication of the transaction information to the financial institution server 208.

The merchant application 244 may also receive information from the financial institution server 208. The merchant application 244, in some embodiments, may receive an offer or offers from the financial institution application 258, such that they merchant application 224 may display the offer or offers to the user 202 on a display on the POS system 206. In this way, the user 202 may receive an offer to purchase the product that the user 202 is already in the process of purchasing. The offer may be displayed on the POS system 206 such that the user 202 may accept the offer prior to the completion of the transaction.

FIG. 2 also illustrates a mobile device 204. The mobile device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the POS system 206, the financial institution server 208, the commercial partner systems 211, and the other financial institution computer systems 210. As such, the communication device 212 generally comprises a modem, server, or other device for communicating with other devices on the network 201.

As further illustrated in FIG. 2, the mobile device 204 comprises computer-readable instructions 220 stored in the memory device 216, which in one embodiment includes the computer-readable instructions 220 of a user application 222. In this way, a user 202 may be able to opt-in to the program, create watch lists for the program, receive offers, deny offers, accept offers, make payments for transactions, and/or the like using the user application 222. A “mobile device” 204 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single mobile device 204 is depicted in FIG. 2, the payment account determination system environment 200 may contain numerous mobile devices 204.

The other financial institution systems 210 are operatively coupled to the financial institution server 208, the POS system 206, the mobile device 204, and/or the commercial partner systems 211 through the network 201. The other financial institution systems 210 have systems with devices the same or similar to the devices described for the financial institution server 208, the POS system 206, and/or the mobile device 204 (i.e., communication device, processing device, and memory device). Therefore, the other financial institution systems 210 communicate with the financial institution server 208, the POS system 206, the commercial partner systems 211, and/or the mobile device 204 in the same or similar way as previously described with respect to each system. The other financial institution computer systems 210, in some embodiments, are comprised of systems and devices that allow the financial institution server 208 to access account information at the other financial institution and/or allow to access transactions the user 202 is currently entering into using accounts at the other financial institutions. In this way the financial institution application 258 may receive recent transaction data and location data from other financial institution systems 210 in order to match the user 202 with an appropriate geographic proximity offer.

The commercial partner system 211 is operatively coupled to the financial institution server 208, the POS system 206, the mobile device 204, and/or the other financial institution systems 210 through the network 201. The commercial partner system 211 has systems with devices the same or similar to the devices described for the financial institution server 208, the POS system 206, and/or the mobile device 204 (i.e., communication device, processing device, and memory device). Therefore, the commercial partner system 211 communicates with the financial institution server 208, the POS system 206, the other financial institution systems 210, and/or the mobile device 204 in the same or similar way as previously described with respect to each system.

The commercial partner systems 211, in some embodiments, provide the financial institution application 258 data with respect to the offers available. This data may include all offers that the commercial partner may wish to provide to users 202 of the geographic proximity offer program. The data may include the offer, limitations on the offer, the product the offer is directed, and the like. The limitations on the offer may be a percentage discount not to exceed, a location limitation, a number of offers provided limitation, a number of products purchased using the offer limitation, etc.

In some embodiments, the commercial partner systems 211 receive requests from the financial institution application 258 to provide users 202 with geographic proximity offers. These requests may come in the form of user 202 watch list data. The financial institution application 258 may request for an offer to be made by the commercial partner if several watch lists include the same or similar products to the products of the commercial partner. The requests may be made from the financial institution application 258 through the network 201 to the commercial partner system 211 for the commercial partner to review and consider.

It is understood that the servers, systems, and devices described herein illustrate one embodiment of the invention. It is further understood that one or more of the servers, systems, and devices can be combined in other embodiments and still function in the same or similar way as the embodiments described herein.

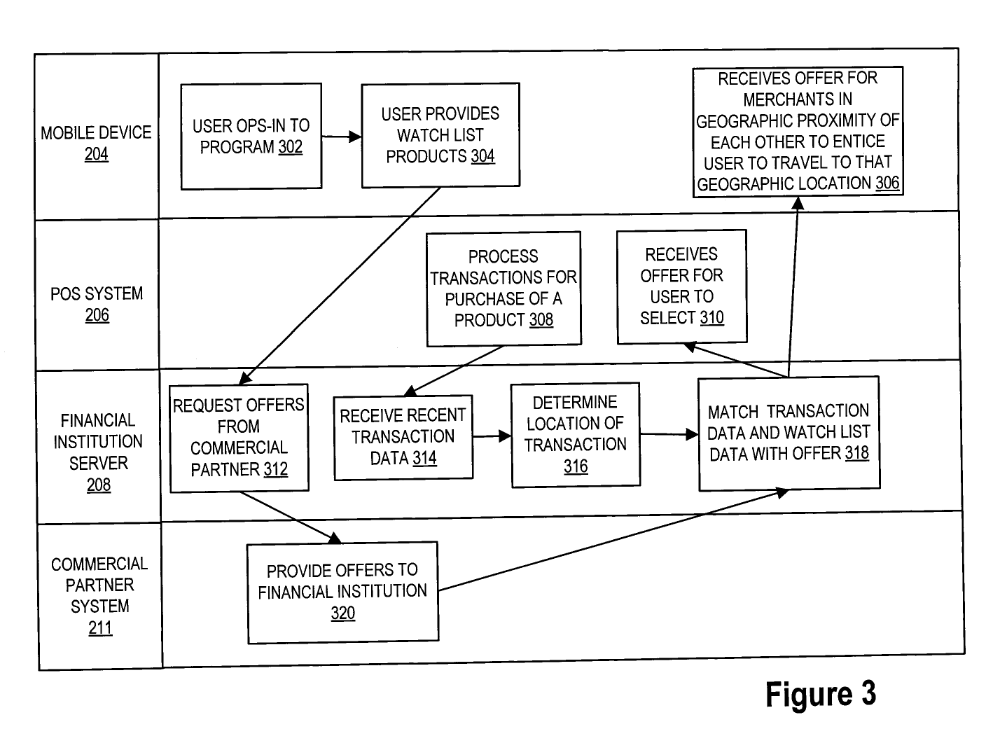

FIG. 3 illustrates a flow chart for the process of receiving geographic proximity offers 300, in accordance with one embodiment of the present invention. The flow chart illustrates the flow of data throughout the system. As illustrated in block 302, a user 202 may opt-in to the geographic proximity offer program using his/her mobile device 204. In block 304 the user 202 may provide the system with a watch list of products the user 202 may wish to purchase. In some embodiments, the user 202 may not provide a watch list of products. In other embodiments, the user 202 may provide products via a watch list. Once the user 202 provides a watch list or opts-in in block 302 or 304 the financial institution server 208 may request offers from commercial partners in block 312. The financial institution server 208 may request offers from commercial partners prior to a user 202 opting into the program. Next the commercial partner system 211 may provide offers to the financial institution for the geographic proximity offer program in block 320. At that point, in some embodiments, the program is triggered when the POS system 206 processes a transaction for a purchase of a product by the user 202 in block 308. In some embodiments, the system may provide the user 202 with offers for merchants in a merchant area independent of a transaction processing event. In this way, the user 202 may receive offers throughout the day, whether the user 202 is shopping or not. The financial institution server 208 may receive the transaction data in block 314. In some embodiments, the transaction data may be recent or current transaction data received from the POS system 206. In some embodiments, the transaction data may be transaction history data received at the financial institution and stored therein. Furthermore, the financial institution system 208 may also determine the location of the recent or historic transaction in block 316.

Once the transaction data 314 and the location data 316 is received, the financial institution server 208 may match the user 202 by the location, transaction, and/or watch list data with an offer in block 318. For example, the data received may determine that the user 202 is currently shopping in a mall, Merchant Area 1 for clothing. The system may then offer the user 202 several offers for several merchants providing clothing, but the offers may be to Merchant Area 2. Merchant Area 2 may be a mall, similar to Merchant Area 1, but the user 202 may have to travel to Merchant Area 2. In this way, the system may provide an offer to a merchant area that the user 202 may not frequent and entice the user 202 to visit and shop at the new merchant area. In another example, the data received may determine that the user 202 always shops for clothing at Merchant Area 2. Although, the data may determine, via GPS data, that the user 202 is currently at home and not shopping, the system may provide several offers for clothing at Merchant Area 2. In this way, when the user 202 is going to shop for clothing, he/she may be enticed by the offers for clothing at Merchant Area 2 and go there instead of another merchant area.

Once a match is determined by the financial institution server 208 the offer is sent to and received by the user 202. In some embodiments, the offers are sent to the POS system 206 in block 310, such that the POS system 206 receives an offer for the user 202 to select. In other embodiments, the offer may also be sent from the financial institution server 208 to the mobile device 204 of the user 202, in this way the mobile device 204 may receive an offer for products from merchants in geographic proximity to the user 202 for various products, in block 306. In some embodiments, the user 202 may receive offer from the geographic proximity offer program through means other than a mobile device 240, such as email, standard mail, online banking, and/or the like. In some embodiments the offer for products provided to the user 202 may be for products from merchants who are in close geographic proximity to each other and not necessarily the user 202.

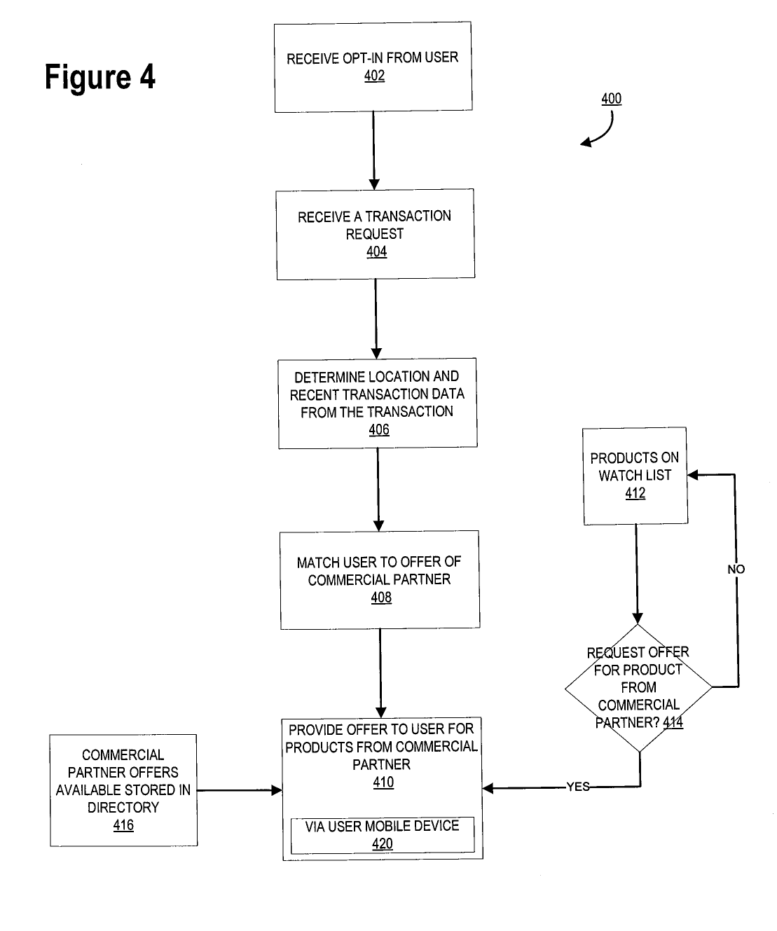

FIG. 4 illustrates a process map of the offer selection process 400, in accordance with one embodiment of the present invention. As illustrated by block 402, the process 400 begins by the system receiving an opt-in from the user 202. In some embodiments, the system may then receive a transaction request from a POS system 206 for the financial institution to authenticate the transaction of a user 202 in block 404. In some embodiments, a transaction request is not received, but instead an offer or offers may be provided to the user 202 without a transaction triggering the offer being provided.

In some embodiments the transaction request may determine the location of the user 202. In yet other embodiments, independent of a transaction request, the system may determine the location and recent transaction data of a user 202 in block 406. The user's 202 location may be determined by location data. Location data may be established by the POS device, social network data of the user 202, an accelerometer, address of the user 202, the location of the mobile device of the user 202, or location of the merchant. In some embodiments, when the user 202 makes a transaction, the financial institution may receive the transaction request from the merchant the user 202 is transacting with. In this way, the system may recognize this transaction request, independent of the authorization process, and determine the location of the user 202 because of the location of the merchant requesting authorization of the transaction. Therefore, the general location of the user 202 may be determined to be within a merchant area determined by the merchant the user 202 is transacting with.

The transaction data comprises the user's 202 recent transactions and the user's 202 transaction history. The user's recent transactions may be determined by recent transaction data. As described in further detail above the financial institution may receive transaction requests to be authorized. Information about the transaction request may also be received by the financial institution, such as the amount of the transaction, the merchant of the transaction, the payment method, and the like. In this way, the system, independent of the authorization of the transaction, may determine, generally the category of products the user 202 is purchasing. For example, if the financial institution is receiving a transaction request from a merchant grocery store, the system may determine that the user 202 is purchasing groceries. The user's 202 transaction history may be determined from data stored in the financial institution server 208 regarding transactions that the user 202 has previously entered into. The transaction history may provide data to the system as to the user's 202 purchase preferences, merchant preferences, and the like.

Then, as illustrated by block 408, a match is determined between a user 202 and an offer of a commercial partner offer. An offer from a commercial partner may be in the form of a discount, rebate, coupon, etc. that may expire within a predetermined amount of time or may be available to the user at any time he/she wishes to make a transaction.

A financial institution commercial partner may be a merchant that has direct ties with a financial institution, such that the merchant may use the financial institutions for their own financial needs. In some embodiments, the commercial partner may be a merchant with no business relationships with the financial institution, but may still wish to provide offers to users 202 of the geographic proximity offer program. In some embodiments, the commercial partner may present offers to the financial institution for the financial institution customers to utilize. In this way a commercial partner merchant may input data regarding products the merchant may wish to provide offers for through the geographic proximity offer program. These inputs may take the form of surveys, questionnaires, sensor data, inputs via an interface, etc. For example, a merchant may be willing to provide some products to users 202 through the geographic proximity offer program. However, the merchant may wish to limit the products available. Therefore, the merchant may provide the financial institution with a list of products available from them for the geographic proximity offer program. In other embodiments, the financial institution may mine data regarding the products a merchant produces to provide a user 202 with a geographic proximity offer for a product from that merchant.

The commercial partner offers received by the system are stored in a directory within the system in block 416. The directory contains data regarding commercial partners and the commercial partner offers provided to the system for the geographic proximity offer program. In this way, the system may match offers from the directory to the location of the user 202, the transaction data of the user 202, and/or the watch list data of the user 202. If the user 202 has provided watch list data in block 412, the system may request an offer for the products on a user's 202 watch list from a commercial partner in decision block 414. In the commercial partner denies the request, the system may continue to request offers for user 202 watch list products from other commercial partner merchants. However, if the commercial partner determines to provide an offer for the product on the user's 202 watch list the offer may be provided to the user 202 in block 410. The offer or offers may be for products from commercial partners in the same merchant area. The merchant area may be one that the user 202 is currently located, has shopped before, or is new to the user 202. The offer or offers may be for one merchant or several merchants within the merchant area as to entice the user 202 to travel to the other merchant area to shop using the offers provided by the geographic proximity offer program. The offers may be provided to the user 202 via the user's 202 mobile device in block 420.

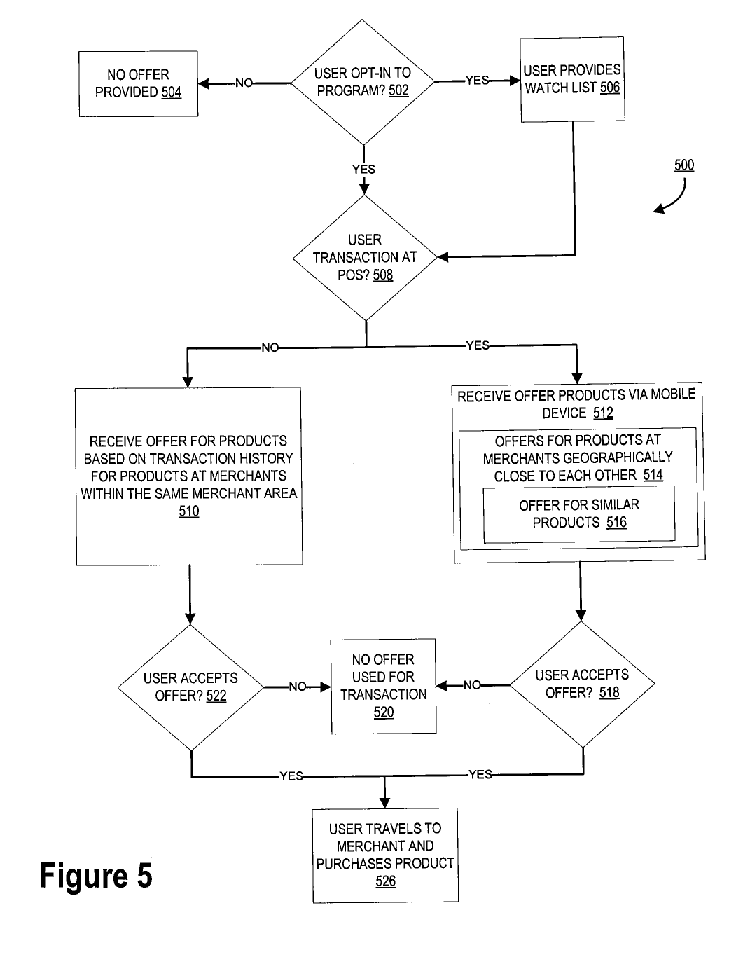

FIG. 5 illustrates a process map of a user's 202 selection process 500. The user 202 may be able to opt-in to the geographic proximity offer program in block 502. Opting-in to the program may be done by selecting a link provided by the financial institution to download an application on the mobile device or an interface accessible through various avenues such as an online banking application provided by the financial institution or through the other financial institution systems 210, an interface, by social networking, by other selection methods which may include, but are not limited to sending a communication via email, text, voice message, video message/conference or like means of selecting an opt-in function.

If the user 202 does not choose to opt-in to the program, the user 202 is not provided offers via the geographic proximity offer program as illustrated by block 504. In some embodiments, the user 202 may still receive offers via the geographic proximity offer program even thought he/she did not opt-in to the program.

If the user 202 has opted in to the program, he/she may provide a watch list in block 506. In some embodiments, the user 202 may not provide products on a watch list. In other embodiments, the user may provide products via a watch list. Watch lists may be created via text messaging, voice messaging, through an interface, applications such as a mobile application, social network sites, etc. In this way, the user 202 may conveniently add or remove products from his/her watch list.

FIG. 6 illustrates a watch list interface 600 in accordance with some embodiments of the invention. The user 202 may provide products that the user 202 may wish to purchase, will purchase, or is interested in purchasing via the watch list interface 600 such that a directory associated with the system may store data regarding the watch list products of the users 202. The watch list interface 600 may be provided from a financial institution to the mobile device 204 of the user 202. The interface may also be provided from a financial institution to the user 202 through online banking means. The user 202 may access the interface in any means he/she would typically access online banking. FIG. 6 provides one embodiment of a watch list interface that allows a user 202 to provide products to the geographic proximity offer program that the user 202 may want to purchase in the future. The financial institution server 208 receives a request from a user 202 to set up a watch list. If the user 202 has not already enrolled, the financial institution server 208 may prompt the user 202 to create a new watch list account. As illustrated in the security section 604, the user 202 creates a user name 606 and password 608 for a new account or otherwise logs into the user's 202 watch list if the user 202 has previously set up a watch list. For example, illustrated in FIG. 6 is a watch list interface 600 that allows a user 202 to create a log-in name and password to set up a watch list. In some embodiments, the watch list interface 600 requires entering information for security reasons 604. At this point, the user 202 may enter a user name 606, a password 608, and a reply to a security question 610. If the user name 606, password 608, and the reply to a security question 610 are satisfactory, the interface prompts the user to the next step in the process. For example, if the user name 606 is being used by a current user, the new user will be prompted to create a different user name 606. In some embodiments, the user 202 may simply add a watch list for the geographic proximity offer program through the user's 202 online banking application. In some embodiments, the interface described herein may be accessed through an application using a mobile device 204.

The user 202 may decide to continue and set up his/her watch list. The watch list interface 600 may provide an add to watch list section 636 for adding products or business to the watch list and subsequently viewing products currently on the user's 202 watch list. In the add products or services section 638, the user 202 may select the products or services in which he/she may wish to add to the watch list for the geographic proximity offer program. The user 202 may add products or services by brand 642 which will allow a user 202 to the brand of a business or product to his/her watch list. The user 202 may add products or services by product 644. For example, a user 202 may provide a watch list product by inputting a product, such as a computer. The user 202 may add products or services by business name 646. For example, a user 202 may be looking for a specific type of store, such as a dry cleaner. He may add dry cleaners to his/her watch list, such that the system may indicate dry cleaners with offers that may be provided to the user 202 via the geographic proximity offer program. The user 202 may add products or services to his/her watch list by creating a new search under the create section 648. In this way, the user 202 may provide new or more refined search criteria to add products or services to his/her watch list. The user 202 may also select from a list of recommendations 650. In some embodiments, the recommendations list combines products that the user 202 typically purchases with products that are reviewed for quality. Products the user 202 typically purchases are determined by the financial institution server 208 via an analysis of the transaction history of the user 202. In this way, the user 202 may add to his/her watch list products that he/she may not have purchased yet, but may be interested in purchasing based on the recommendations. In some embodiments, the recommendation list may be provided from the financial institution and data the financial institution acquires. Once the user 202 has selected the product or business by brand 642, by product 644, by business 646, by creating a search 648, or by a recommendation 650 the user 202 may add the product, service, or business to his/her current watch list 640, by selecting the add button.

Once the user 202 has completed adding his favorites he/she may view his/her current watch list that he/she has compiled in section 640. The watch list has a compilation of all the products, services, or business that the user 202 has added. The products, services, or business may have been added during a previous log-in session or during the current log-in session. If the user 202 wishes, he/she may remove a product from the current watch list 640 if it is no longer a product the user 202 may wish to purchase. Once the user 202 has completed adding or removing products, services, or business from his/her current watch list 640, to save data added or removed the user 202 may select the finish button 652.

The watch list interface 600 illustrated in FIG. 6 also provides a section indicating the current geographic proximity offers available to the user 202 in section 612. In this way, the system may provide offers that may be available to the user 202 at this time. For example, these offers may be offers that have been provided to the user 202 previously and have not yet expired. These offers may also include offers that the user 202 has not yet received, but are available offers for merchants within a merchant area. The merchant area may be an area the user 202 has never been, an area the user 202 frequents, or an area that the user 202 may occasionally frequent. Therefore, the user 202 may not have to be purchasing a different product in order to receive geographic proximity offer program offers. Therefore, if the user 202 is interested in shopping for products he/she may log into his/her watch list interface 600 to receive offers currently available. The offers available to the user 202 in section 612 may include information about the product, service, or business such as the product of the offer 614, the merchant providing the offer 616, and the offer 618. In the example illustrated in FIG. 6, the user 202 may have an offer available to him/her for product B at merchant 1 for 25% off the original price.

Using the interface or other means the user 202 may provide watch list products, services, or business to the geographic proximity offer program at any time convenient to the user 202. In this way, the user 202 may provide products, services, or business to the watch list at any time they have access to online banking or an application on the mobile device 204 of the user 202. Products, services, or business may also be provided to watch lists by the user 202 by social networks. In this way, the individual may provide a list of products, services, or business he/she recommends on his social network page.

Once the user 202 has opted-in to the geographic proximity offer program and has provided a watch list a triggering event, such as a transaction at a POS may occur, as illustrated in block 508 of FIG. 5. In some embodiments, if the user 202 does not enter into a transaction at a POS, the system may still provide the user 202 with an offer, as illustrated in block 510. If the user 202 does enter into a transaction in decision block 508, the user may receive offers from the geographic proximity offer program, as illustrated in block 512.

In one embodiment, offers from the geographic proximity offer program may received by the user 202 when a transaction did not occur, as illustrated in block 510. The offer provided in block 510 is an offer based on the user's 202 transaction history for products at merchants that are within the same merchant area. For example, if the user 202 is in his/her home, the system may provide the user 202 with offers for products from merchants within a merchant area, such that the offers may entice the user 202 to shop at that merchant area. As illustrated in decision block 522 the user 202 may select to accept or decline the offer provided to him/her. If the user 202 declines to receive the offer, the user will not use the offer for a transaction for a product purchase, as illustrated in block 520. If the user 202 accepts the offer in decision block 522, the user may travel to the merchant area and purchase the product associated with that offer, as illustrated in block 526. In some embodiments, the user 202 may provide the offer that he/she received to other individuals associated with the user 202. In this way, the offer or offers may be used by other individuals which may be enticed to travel to a different merchant area to shop.

As illustrated in block 512 of FIG. 5, if the user 202 is receiving offers for other products upon a transaction at a POS, the offer may be received from the system at the user's 202 mobile device. In some embodiments, the offer may be received independent of the user's 202 mobile device. As such, the offer may be provided to the user 202 via standard mail, email, voice mail, etc., that may or may not be directly associated with the user's 202 mobile device. The data received from the POS system 206 when a transaction is entered into in decision block 508 may provide location data and transaction data. This data is analyzed along with watch list data by the system to determine a match between an offer for a product and the user 202. The offers for products are received from commercial partners of the financial institution and are stored in a directory which may be search to determine a match. In this way, the financial institution application 258 may compare the directory of offers to the data received regarding the user 202 to determine an appropriate offer to provide the user 202 via the geographic proximity offer program, in block 512.

With the matches between the directory and the data from the transaction. The user 202 may receive offers for products via the geographic proximity offer program at the user's 202 mobile device 206, as illustrated in block 512. The offers provided may be for products located at merchants that are geographically close to each other as illustrated in block 514. In this way, multiple offers from merchants within one merchant area may be provided to the user 202 such that the multiple offers may entice the user 202 to travel to that merchant area. Offers may be in the form of familiar merchant offers, familiar product offers, similar products, competing merchant offers, and/or competing product offers. These offers may be include, but are not limited to discounts, coupons, etc. that may expire within a predetermined amount of time or may be available to the user 202 at any time he/she wishes to make a transaction. In some embodiments, the user 202 may provide the offers to other individuals via social networking, emailing, messaging, etc. such that the other individuals may be enticed to visit a merchant. Geographic proximity offers may be discounts that the merchant may provide to other customers or the offers may be discounts, etc. provided specifically to users 202 of the geographic proximity offer program. In some embodiments, the user 202 may be provided with several different geographic proximity offers at one time. For example, a user 202 may be provided a familiar merchant offer, a familiar product offer, a similar product offer, and a competing product offer.

Familiar merchant offers may be offers that may be used at a merchant that the user 202 has previously shopped and purchased products from, as determined by the financial institution server 208 by reviewing the user's 202 transaction history. Familiar product offers may be offers that may be used for products that the user 202 has purchased before, as determined by the financial institution server 208 by reviewing the user's 202 transaction history. Similar product offers may be offers for products similar to those that the user 202 is currently purchasing in the user transaction 508. Similar products may be determined by the system based on the location data and recent transaction data. Competing merchant offers may be offers for use at a competitor merchant. The competitor merchant may be a competitor of the merchant the user 202 is transacting with or a familiar merchant of the user 202. This way the system may provide the user 202 an opportunity to visit a new merchant that provides the user 202 with an offer. Competing product offers may be offers for use to purchase a competing product, other than the products that are located at the merchant the user 202 is currently placing a transaction or other than familiar products of the user 202. The user 202, in this instance as an example, is presented with an offer for a similar product in block 516.

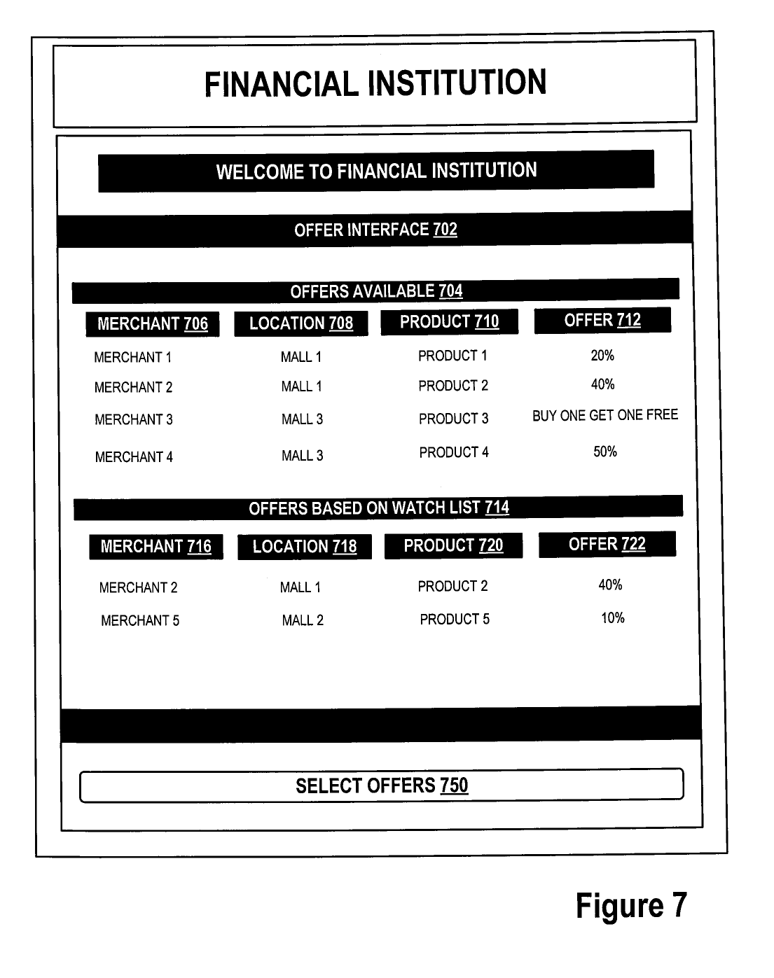

The geographic proximity offers provided to the user 202 may be presented to the user via his/her mobile device using an interface. FIG. 7 illustrates an offer interface 702 in accordance with some embodiments of the invention.

As illustrated in FIG. 7, an offer interface 702 presents the geographic proximity offers available to the user 202 based on the user's 202 location data, recent transaction data, and watch list data. In some embodiments, the offer interface 702 can be displayed to the user 202 on the mobile device 204 whenever the user 202 enters into a transaction, by accessing a watch list, or when a user 202 accesses the geographic proximity offer program. At section 704 of the offer interface 702 the geographic proximity offers that are currently available to the user 202 are presented to the user 202. The available offers may provide information such as the merchant 706, the merchant location (or merchant area) 708, the product 710, and the offer 712. In the example illustrated in FIG. 7, the user 202 has offers from four merchants, Merchant 1, Merchant 2, Merchant 3, and Merchant 4. Each of the merchants may be located with the same merchant area or different merchant areas. In this example, the merchants are located at several merchant areas including Mall 1 and Mall 3. Each merchant is providing an offer for different products with different offers associated with each product. For example Product 2 is offered for 40% off its original price whereas Product 4 is being offered for 50% off.

As illustrated in FIG. 7 at section 714, the system may also provide the user 202 with offers for products on the user's 202 watch list. These products may be located at merchant locations that based on product on the user's 202 watch list. Again, information about these offers are provided, such as the merchant providing the offer 716, the location of the merchant 718, the product associated with the offer 720, and the offer 722. If the user 202 wishes to use an offer presented to him/her via the offer interface 702, he/she may select the offers by selecting the select offer button 750.

Referring back to FIG. 5, the user may accept or decline the offer, as illustrated in decision block 518. If the user 202 does declines the offer, then no offer is provided to the user 202 for purchase of a product, as illustrated in block 520. If the user 202 accepts the offer in decision block 518 the user 202 may travel to the merchant providing the offer and purchase the product at the offer's discounted price, as illustrated in block 526.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing offers to a user, the method comprising:
receiving financial transaction data associated with a user;
determining from the financial transaction data one or more geographic locations where financial transactions in the financial transaction data occurred;
determining from a data store of product offers, via a computer device processor, one or more selected product offers offered at a geographic location different from the one or more geographic locations associated with the financial transaction data; and
providing the selected product offers to the user associated with the financial transaction data to thereby entice the user to shop at the geographic location different from the one or more geographic locations associated with the financial transaction data.

2. The method according to claim 1 further comprising:
determining from the financial transaction data at least one of one or more categories associated with the financial transaction data, and
wherein said determining selected product offers further comprises determining selected product offers designated in the same categories as the one or more categories associated with the financial transaction data where the products underlying the product offers are offered at geographic locations different from the one or more geographic locations associated with the financial transaction data.

3. The method according to claim 1 further comprising:
determining from the financial transaction data at least one of one or more categories associated with the financial transaction data, and
wherein said determining selected product offers further comprises determining selected merchants that provide products in the same categories as the one or more categories associated with the financial transaction data and providing selected product offers from the selected merchants where the selected merchants are located at geographic locations different from the one or more geographic locations associated with the financial transaction data.

4. The method of claim 1, wherein said determining one or more selected product offers comprises determining one or more selected products offered at a geographic location that is a predetermined distance from the one or more geographic locations associated with the financial transaction data.

5. The method of claim 1, wherein said determining one or more selected product offers comprises determining one or more selected products offered at a geographic location that is a predetermined distance from an address associated with the user.

6. The method claim 1, wherein said determining one or more selected product offers comprises determining one or more selected products offered at a geographic location that is a predetermined distance from the current location of the user.

7. The method of claim 1, wherein said determining one or more selected product offers comprises determining product offers associated with an area of merchants that is different from the one or more geographic locations where financial transactions in the financial transaction data occurred.

8. The method of claim 1, wherein said determining one or more selected product offers comprises varying the value of the product offers based on a difference in a geographic location associated with the product offers and the geographic location associated with the financial transaction data.

9. The method of claim 1, wherein said determining from the financial transaction data one or more geographic locations where financial transactions in the financial transaction data occurred is based at least in part on a point-of-sale device associated with the financial transactions.

10. A system for providing offers to a user, the system comprising:
a memory device;
a communication device; and
a processing device operatively coupled to the memory device and the communication device, wherein the processing device is configured to execute computer-readable program code to:
receive financial transaction data associated with a user;
determine from the financial transaction data one or more geographic locations where financial transactions in the financial transaction data occurred;
determine from a data store of product offers one or more selected product offers offered at a geographic location different from the one or more geographic locations associated with the financial transaction data; and
provide the selected product offers to the user associated with the financial transaction data to thereby entice the user to shop at the geographic location different from the one or more geographic locations associated with the financial transaction data.

11. The system of claim 10 further comprising the processing device configured to execute computer-readable program code to:
determine from the financial transaction data at least one of one or more categories associated with the financial transaction data, and
wherein said determining selected product offers further comprises determining selected product offers designated in the same categories as the one or more categories associated with the financial transaction data where the products underlying the product offers are offered at geographic locations different from the one or more geographic locations associated with the financial transaction data.

12. The system of claim 10 further comprising the processing device configured to execute computer-readable program code to:
determine from the financial transaction data at least one of one or more categories associated with the financial transaction data, and
wherein said determining selected product offers further comprises determining selected merchants that provide products in the same categories as the one or more categories associated with the financial transaction data and providing selected product offers from the selected merchants where the selected merchants are located at geographic locations different from the one or more geographic locations associated with the financial transaction data.

13. The system of claim 10, wherein said determining one or more selected product offers comprises determining one or more selected products offered at a geographic location that is a predetermined distance from the one or more geographic locations associated with the financial transaction data.

14. The system of claim 10, wherein said determining one or more selected product offers comprises determining one or more selected products offered at a geographic location that is a predetermined distance from an address associated with the user.

15. The system of claim 10, wherein said determining one or more selected product offers comprises determining one or more selected products offered at a geographic location that is a predetermined distance from the current location of the user.

16. The system of claim 10, wherein said determining one or more selected product offers comprises determining product offers associated with an area of merchants that is different from the one or more geographic locations where financial transactions in the financial transaction data occurred.

17. The system of claim 10, wherein said determining one or more selected product offers comprises varying the value of the product offers based on a difference in a geographic location associated with the product offers and the geographic location associated with the financial transaction data.

18. The system of claim 10, wherein said determining from the financial transaction data one or more geographic locations where financial transactions in the financial transaction data occurred is based at least in part on a point-of-sale device associated with the financial transactions.

19. A computer program product for providing offers to a user, the computer program product comprising at least one non-transitory computer-readable medium having computer-readable program code portions embodied therein, the computer-readable program code portions comprising:
an executable portion configured for receiving financial transaction data associated with a user;
an executable portion configured for determining from the financial transaction data one or more geographic locations where financial transactions in the financial transaction data occurred;
an executable portion configured for determining from a data store of product offers one or more selected product offers offered at a geographic location different from the one or more geographic locations associated with the financial transaction data; and
an executable portion configured for providing the selected product offers to the user associated with the financial transaction data to thereby entice the user to shop at the geographic location different from the one or more geographic locations associated with the financial transaction data.

20. The computer program product of claim 19 further comprising:
an executable portion configured for determining from the financial transaction data at least one of one or more categories associated with the financial transaction data, and
wherein said determining selected product offers further comprises determining selected product offers designated in the same categories as the one or more categories associated with the financial transaction data where the products underlying the product offers are offered at geographic locations different from the one or more geographic locations associated with the financial transaction data.

21. The computer program product of claim 19 further comprising:
an executable portion configured for determining from the financial transaction data at least one of one or more categories associated with the financial transaction data, and
wherein said determining selected product offers further comprises determining selected merchants that provide products in the same categories as the one or more categories associated with the financial transaction data and providing selected product offers from the selected merchants where the selected merchants are located at geographic locations different from the one or more geographic locations associated with the financial transaction data.

22. The computer program product of claim 19, wherein said determining one or more selected product offers comprises determining one or more selected products offered at a geographic location that is a predetermined distance from the one or more geographic locations associated with the financial transaction data.

23. The computer program product of claim 19, wherein said determining one or more selected product offers comprises determining one or more selected products offered at a geographic location that is a predetermined distance from an address associated with the user.

24. The computer program product of claim 19, wherein said determining one or more selected product offers comprises determining one or more selected products offered at a geographic location that is a predetermined distance from the current location of the user.

25. The computer program product of claim 19, wherein said determining one or more selected product offers comprises determining product offers associated with an area of merchants that is different from the one or more geographic locations where financial transactions in the financial transaction data occurred.

26. The computer program product of claim 19, wherein said determining one or more selected product offers comprises varying the value of the product offers based on a difference in a geographic location associated with the product offers and the geographic location associated with the financial transaction data.

27. The computer program product of claim 19, wherein said determining from the financial transaction data one or more geographic locations where financial transactions in the financial transaction data occurred is based at least in part on a point-of-sale device associated with the financial transactions.

28. A method for providing offers to a user, the method comprising:
receiving financial transaction data from a point-of-sale device associated with a merchant, wherein the financial transaction data is associated with a user;
determining from the financial transaction data a geographic location of the point-of-sale device;
determining from a data store of product offers, via a computer device processor, one or more selected product offers offered at a geographic location different from the geographic location of the point-of-sale device; and
providing the selected product offers to the user associated with the financial transaction data from the points-of-sale device to thereby entice the user to shop at the geographic location different from the geographic location of the point-of-sale device.
